(19) United States
(12) Patent Application Publication
(10) Pub. No.: US 2013/0057567 A1
(43) Pub. Date: Mar. 7, 2013

(54) Color Space Conversion for Mirror Mode

(71) Applicants: Michael Frank, Sunnyvale, CA (US); Brijesh Tripathi, San Jose, CA (US); Peter F. Holland, Los Gatos, CA (US)

(72) Inventors: Michael Frank, Sunnyvale, CA (US); Brijesh Tripathi, San Jose, CA (US); Peter F. Holland, Los Gatos, CA (US)

(21) Appl. No.: 13/226,604

(22) Filed: Sep. 7, 2011

(51) Int. Cl. G09G 5/02

(52) U.S. Cl. 345/589

(57) ABSTRACT

The same pixel stream may be displayed on an internal display and an external display while maintaining the original aspect ratio corresponding to the internal display dimensions. A connector with limited number of pins may only support a two-wire display port interface to the external display, which may not provide enough bandwidth to transmit the full resolution image to the external display. To transmit the full resolution image, a color space conversion from RGB space to YCbCr color space may be performed. The Luma component may be transmitted at full resolution, while the chroma components may be scaled. Accordingly, there is no loss of image resolution, while some amount of color resolution may be lost. However, there is no need to retime frames within the system on chip (SOC), and the same pixel stream may be used as the basis for display on both the internal and the external display.

### BACKGROUND

1. Field of the Invention

This invention is related to the field of graphical information processing, more particularly, to displaying mirror images on multiple displays.

2. Description of the Related Art

Part of the operation of many computer systems, including portable digital devices such as mobile phones, notebook computers and the like is the use of some type of display device, such as a liquid crystal display (LCD), to display images, video information/streams, and data. Accordingly, these systems typically incorporate functionality for generating images and data, including video information, which are subsequently output to the display device. Such devices typically include video graphics circuitry to process images and video information for subsequent display.

In digital imaging, the smallest item of information in an image is called a “picture element”, more generally referred to as a “pixel”. For convenience, pixels are generally arranged in a regular two-dimensional grid. By using this arrangement, many common operations can be implemented by uniformly applying the same operation to each pixel independently. Since each pixel is an elemental part of a digital image, a greater number of pixels can provide a more accurate representation of the digital image. The intensity of each pixel can vary, and in color systems each pixel has typically three or four components such as red, green, blue, and black.

Most images and video information displayed on display devices such as LCD screens are interpreted as a succession of image frames, or frames for short. While generally a frame is one of the many still images that make up a complete moving picture or video stream, a frame can also be interpreted more broadly as simply a still image displayed on a digital (discrete, or progressive scan) display. A frame typically consists of a specified number of pixels according to the resolution of the image/video frame. Information associated with a frame typically consists of color values for every pixel to be displayed on the screen. Color values are commonly stored in 1-bit monochrome, 4-bit palletized, 8-bit palletized, 16-bit high color and 24-bit true color formats. An additional alpha channel is oftentimes used to retain information about pixel transparency. The color values can represent information corresponding to any one of a number of color spaces.

One color space is YPbPr, which is used in video electronics, and is commonly referred to as “component video”. YPbPr is the analog representation of the YCbCr color space, which is associated with digital video. The YPbPr color space and YCbCr color space are numerically equivalent, with scaling and offsets applied to color values in the YPbPr color space to obtain corresponding color values in the YCbCr color space. Color space conversion is the translation of the representation of a color value from one color space to another, and typically occurs in the context of converting an image that is represented in one color space to another color space, with the goal of making the translated image look as similar as possible to the original. For example, color values in the YPbPr color space are created from the corresponding gamma-adjusted color values in the RGB (red, green and blue) color space, using two defined constants K_{B} and K_{R}. In general, color video and/or image information may be separated into Chrominance (chroma or C for short, where Cb represents the blue-difference chroma component and Cr represents the red-difference chroma component) and Luminance (luma, or Y for short) information. Chrominance signals are used to convey the color information separately from the accompanying Luminance signal, which represents the “black-and-white” or achromatic portion of the image, also referred to as the “image information”.

In certain situations, there is a need to display the same images concurrently on multiple displays of a computer system. For example, a computing device may have an internal display, and may also include an interface to which an external display can be coupled. It may be desirable to couple an external display to the device even if the device already has an internal display, for example when giving a presentation—such as a software demonstration to an audience in a large room. The presenter may view the demonstration on the device's internal display while the audience views the demonstration on the external display. In making such a presentation, it is typically desirable for the two displays to show the same images at the same time (or at least such that differences between the two displays are not visually apparent). Achieving such a result, however, may require significant resources of the computing device. Such an allocation of resources may not make sense from a design standpoint, particularly where real estate is at a premium on the computing device (e.g., the computing device is a tablet or smart phone device) and the presentation feature described above is not frequently used. Further complicating the situation is the multiplicity of possible external displays of differing resolutions that may be attached to the computing device

Other corresponding issues related to the prior art will become apparent to one skilled in the art after comparing such prior art with the present invention as described herein.

### SUMMARY

In one set of embodiments, a video/image stream may be displayed, in mirror mode, on an internal display and an external display. To provide the stream to the external display, a two-wire display port interface to the external display may be supported on a thirty-pin connector on the device sourcing the video/image stream. In one embodiment, the device is an iPad™. For a certain screen resolution, for example a 2048×1536 screen resolution, there may not be enough bandwidth on the two-wire interface to transmit the full resolution image. In order to maintain a specified aspect ratio, for example a 4:3 aspect ratio (or a 3:4 aspect ratio, if the device is an iPad™ that is rotated) and the original image resolution, a color space conversion may be performed from an RGB color space (in which the video/image stream is sourced to the internal display) to the YCbCr color space, to allow for chroma subsampling.

By converting the stream into luminance and chrominance information, the stream may be encoded by implementing less resolution for chroma information than for luma information, taking advantage of the human visual system's lower acuity for color differences than for luminance. Since human vision has finer spatial sensitivity to luminance (“black and white”) differences than chromatic (color) differences, the chromatic information may be transmitted to the external display at a lower resolution, optimizing perceived detail at a particular bandwidth. In other words, the Y (Luma) component may be transmitted at full resolution, while the chroma (Cb and Cr) components may be scaled. Accordingly, there is no loss of image resolution, while some amount of color resolution is lost, but this loss of the color resolution isn't as perceptible as would be a loss of image resolution. This also avoids the need to retime frames within the system on chip (SOC) sourcing the video/image stream, and the horizontal and vertical dimensions of the image frame may be resized off-chip using an external scaler/rotator unit.

### BRIEF DESCRIPTION OF THE DRAWINGS

The following detailed description makes reference to the accompanying drawings, which are now briefly described.

FIG. 1 is a block diagram of one embodiment of a computer system having multiple displays.

FIG. 2 a block diagram of one embodiment of a computer system that includes a computing device with an internal converter scaling unit.

FIGS. 3A and 3B illustrate examples of downscaling for a secondary display while maintaining an aspect ratio of an image on a primary display.

FIG. 4 a block diagram of one embodiment of a converter scaling unit.

FIG. 5 is a more detailed block diagram of one embodiment of a converter scaling unit;

FIG. 6A is a flowchart depicting one embodiment of a method for generating an output frame from an input frame;

FIG. 6B is a flowchart depicting one embodiment of a method for operating a computer system to concurrently display images;

FIG. 6C is a flowchart depicting one embodiment of a method for displaying images on multiple displays in mirror mode;

FIG. 7 is a diagram illustrating exemplary delaying of an input line of pixels and corresponding control signals;

FIGS. 8A and 8B are exemplary diagrams illustrating timing of vertical sync and horizontal sync signals, respectively; and

FIG. 9 is an exemplary timing diagram showing alternating output of downscaled Cr and Cb components per display port clock cycle.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits and/or memory storing program instructions executable to implement the operation. The memory can include volatile memory such as static or dynamic random access memory and/or nonvolatile memory such as optical or magnetic disk storage, flash memory, programmable read-only memories, etc. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph six interpretation for that unit/circuit/component.

### DETAILED DESCRIPTION OF EMBODIMENTS

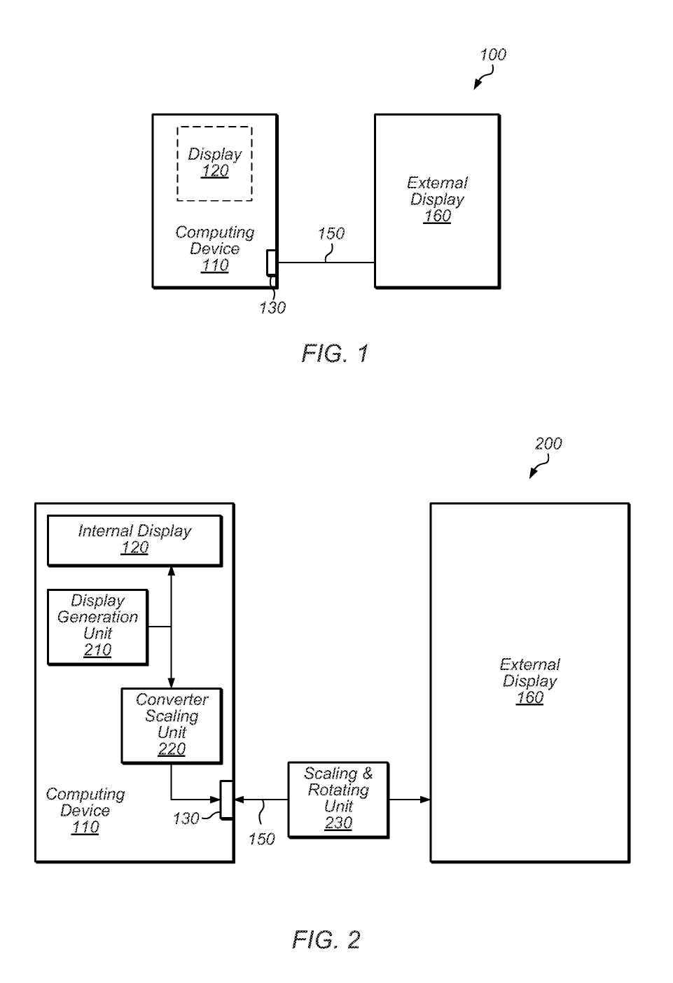

FIG. 1 shows a block diagram of one embodiment of a computer system with multiple displays. Computer system 100 includes computing device 110, which may be any suitable type of computing device. In one embodiment, device 110 is a tablet computing device such as an iPad™ product.

As shown in FIG. 1, device 110 is coupled to display 120. In one embodiment, display 120 is integrated or internal to computing device 110. This display may be referred to as the “primary” display, or “internal display” of device 110. In some embodiments, primary display 120 may be connected to device 110 through an external interface. Display 120 is represented with a dotted line in FIG. 1 to indicate that it may be located either internal or external to device 110. As used herein, a display, or graphics display refers to any device that is configured to present a visual image in response to control signals to the display. A variety of technologies may be used in the display, such as cathode ray tube (CRT), thin film transistor (TFT), liquid crystal display (LCD), light emitting diode (LED), plasma, etc. A display may also include touch screen input functionality, in some embodiments. The display devices may also be referred to as panels, in some cases.

In addition to display 120, computing device 110 includes an external interface 130 that may couple to an external or secondary display 160 via connection 150. Interface 130 may be any type of standard or proprietary interface, and may be wired or wireless. A given interface 130 can be understood to have a “data width” (e.g., a number of pins) dedicated to a specified amount of data the interface can transfer at a given point in time. Specifically, interface 130 may have a specified number of lines dedicated to transferring graphics (e.g. video/image) information to external display 160. Interface 130 may also be configured to provide data to other types of external devices that may also be coupled to computing device 110 via interface 130, in lieu of or in addition to external display 160. Connection 150 is a logical representation of the connection between device 110 and secondary display 160. In various embodiments, connection 150 may be wireless. In other embodiments, connection 150 may be wired, and may include one or more intervening hardware components, such as a vertical scaling unit discussed below. Like primary display 120, secondary display 160 may be any suitable type of device. In one embodiment, secondary display 160 is a high-definition TV (HDTV) compatible device.

Computing device 110 may include various structures (not depicted in FIG. 1) that are common to many computing devices. These structures include one or more processors, memories, graphics circuitry, I/O devices, bus controllers, etc.

Processors within device 110 may implement any instruction set architecture, and may be configured to execute instructions defined in that instruction set architecture. The processors may employ any microarchitecture, including scalar, superscalar, pipelined, superpipelined, out of order, in order, speculative, non-speculative, etc., or combinations thereof. The processors may include circuitry, and optionally may implement microcoding techniques. The processors may include one or more L1 caches, as well one or more additional levels of cache between the processors and one or more memory controllers. Other embodiments may include multiple levels of caches in the processors, and still other embodiments may not include any caches between the processors and the memory controllers.

Memory controllers within device 110 may comprise any circuitry configured to interface to the various memory requestors (e.g. processors, graphics circuitry, etc.). Any sort of interconnect may be supported for such memory controllers. For example, a shared bus (or buses) may be used, or point-to-point interconnects may be used. Hierarchical connection of local interconnects to a global interconnect to the memory controller may be used. In one implementation, a memory controller may be multi-ported, with processors having a dedicated port, graphics circuitry having another dedicated port, etc.

Memory within device 110 may be any type of memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR2, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with a system on a chip in a chip-on-chip configuration, a package-on-package configuration, or a multi-chip module configuration.

Graphics controllers within device 110 may be configured to render objects to be displayed into a frame buffer in the memory. The graphics controller may include one or more graphics processors that may execute graphics software to perform a part or all of the graphics operation, and/or hardware acceleration of certain graphics operations. The amount of hardware acceleration and software implementation may vary from embodiment to embodiment. More specifically, referring to FIG. 2, device 110 may include a display generation unit 210 which may generate the pixels to be displayed on internal display 120 as well as on external display 160. Display generation unit 210 may include memory elements for storing video frames/information and image frame information. In some embodiments, the video frames/information may be represented in a first color space, according the origin of the video information. For example, the video information may be represented in the YCbCr color space. At the same time, the image frame information may be represented in the same color space, or in another, second color space, according to the preferred operating mode of the graphics processors. For example, the image frame information may be represented in the RGB color space. Display generation unit 210 may include components that blend the processed image frame information and processed video image information to generate output frames that may be stored in a buffer, from which they may be provided to a display controller for display on the internal display 120. In one set of embodiments, the blended processed image/video frame information is provided to internal display 120 as pixel data represented in the RGB color space.

In one set of embodiments, the output frames may be presented to the display controller through an asynchronous FIFO (First In First Out) buffer in display generation unit 210. The display controller may control the timing of the display through a Vertical Blanking Interval (VBI) signal that may be activated at the beginning of each vertical blanking interval. This signal may cause the graphics processor(s) to initialize (Restart) and start (Go) the processing for a frame (more specifically, for the pixels within the frame). Between initializing and starting, configuration parameters unique to that frame may be modified. Any parameters not modified may retain their value from the previous frame. As the pixels are processed and put into the output FIFO, the display controller may issue signals (referred to as pop signals) to remove the pixels at the display controller's clock frequency (indicated as VCLK). The pixels thus obtained may be queued up in the output FIFO at the clock rate (indicated as CLK) of the processing elements within display generation unit 210, and fetched by the display controller at the display controller's clock rate of VCLK.

In various embodiments, different structures within computing device 110 may be located within a system on a chip (SoC). In one implementation, device 110 includes integrated display 120, an SoC, memory, and interface 130, with the SoC coupled to the display, the memory, and the interface. Other embodiments may employ any amount of integrated and/or discrete implementations.

Computing device 110 may operate to display frames of data. Generally, a frame is data describing an image to be displayed. As mentioned above, a frame may include pixel data describing the pixels included in the frame (e.g. in terms of various color spaces, such as RGB or YCbCr), and may also include metadata such as an alpha value for blending. Static frames may be frames that are not part of a video sequence. Alternatively, video frames may be frames in a video sequence. Each frame in the video sequence may be displayed after the preceding frame, at a rate specified for the video sequence (e.g. 15-30 frames a second). Video frames may also be complete images, or may be compressed images that refer to other images in the sequence. If the frames are compressed, a video pipeline in device 110 may decompress the frames.

As also mentioned above, a display generation unit 210 within device 110 may be configured to read frame data from memory and to process the frame data to provide a stream of pixel values for display. The display generation unit may provide a variety of operations on the frame data (e.g. scaling, video processing for frames that are part of a video sequence, etc.). The unit may be configured as a display pipeline in some embodiments. Additionally, the display generation unit may be configured to blend multiple frames to produce an output frame. For example, in one embodiment, each frame pixel may have an associated alpha value indicating its opaqueness. The display generation unit may include one or more user interface blocks configured to fetch and process static frames (that is, frames that are not part of a video sequence) and one or more video pipelines configured to fetch and process frames that are part of a video sequence. The frames output by the user interface blocks may be blended with a video frame output by the video pipeline. In one embodiment, the display generation unit may be configured to provide the output pixel stream to pixel processing units (PPUs) within device 110.

Generally, a pixel value in a stream of pixel values may be a representation of a pixel to be displayed on a display coupled to device 110. The pixel value may include a one or more color space values. For example, in an RGB color space, the pixel value includes a red value, a green value, and a blue value. Each value may range from zero to 2^{N}−1, and describes an intensity of the color for that pixel. Similarly, in the YCbCr color space, the pixel value includes a Y value, a Cr value, and a Cb value. The location of a pixel on the display may be inferred from the position of the corresponding pixel value in the pixel stream. For example, the pixel stream may be a series of rows of pixels, each row forming a line on the display screen. In a progressive-mode display, the lines are drawn in consecutive order and thus the next line in the pixel stream is immediately adjacent to the previous line. In an interlaced-mode display, consecutive passes over the display draw either the even or the odd lines, and thus the next line in the pixel stream skips one line from the previous line in the pixel stream. For brevity, the stream of pixel values may be referred to as a pixel stream, or a stream of pixels. Pixel processing units within device 110 may be configured to perform various pixel operations on the pixel stream and may provide the processed pixel stream to the respective physical interfaces (PHYs).

Generally, a pixel operation may be any operation that may be performed on a stream of pixels forming a line on a display. For example, pixel operations may include one or more of: color space conversions, backlight control, gamma correction, contrast ratio improvement, filtering, dithering, etc. The PHYs may generally include the circuitry that physically controls the corresponding displays. The PHYs may drive control signals that physically control the respective display panels in response to the pixel values. Thus, for example, a PHY for a display that is controlled by RGB signals may transmit voltages on the R, G, and B signals that correspond to the R, G, and B components of the pixel. There may also be a display clock that may be transmitted by the PHYs, or the display clock may be embedded in one of the control signals. Different PHYs for different displays may have clocks that are within different clock domains.

A “clock domain” refers to the circuitry that is controlled responsive to a given clock. Clocked storage devices such as latches, registers, flops, etc. may all be configured to launch and capture values responsive to the given clock, either directly or indirectly. That is, the clock received by a given clocked storage device may be the given clock or a clock that is derived from the given clock. On the other hand, clocked storage devices in a different clock domain launch/capture values responsive to a different clock that may not have a synchronous relationship to the given clock.

It is often desirable to use computing device 110 to make a presentation—for example, to an audience in a large room. In such a situation, the size of primary display 120 may be inadequate for audience members. To facilitate such presentations, secondary display 160 may be coupled to device 110 via interface 130 and connection 150. In this manner, the presenter may view the presentation on display 120 while the audience views the presentation on display 160. Such dual display becomes less useful, however, if images on the displays are not synchronized (that is, someone viewing the two images can visually discern image drift or other visual discrepancies). Stated another way, it is often desirable that the two images be displayed concurrently, such that when the presenter is describing a feature of the presentation appearing on display 120, this same feature is also appearing on display 160 at the same time. (As will be described further below, there may be some inherent phase difference between images on different display. As used herein, however, references to “synchronized,” “synchronous,” or “concurrent” display of images includes display of images on different displays that do not have visually discernable image drift.)

Concurrent display of images becomes more difficult when the internal display and external display have different resolutions (i.e., different number of pixels in the horizontal and vertical directions). One possible solution is to have different display generation units for each display. Such an approach has significant drawbacks. Consider a game developer who wishes to demonstrate a new video game using internal and external displays. If the video game is pushing the processing power of device 110, it may be a waste of processing power to have a second display generation unit running for the external display, when in effect it would be rendering the same image as for the first display generation unit. Thus, such a configuration might not allow the developer the ability to showcase the video game running at peak performance.

An alternative solution is the use of a “mirror mode” in which a single display generation unit is used to provide output (e.g., pixels) to displays 120 and 160. This solution involves fetching data from memory only a single time (as opposed to twice in the solution described above). In some embodiments of computing device 110, however, the use of mirror mode may still have shortcomings. In particular, in some instances, the data width of interface 130 may not provide sufficient bandwidth to concurrently display images on both displays. For example, interface 130 may be sufficient for many data transfer applications, but may not have enough pins to display video on an HDTV secondary display concurrently with the primary display. In order to facilitate concurrent display of images through such a connector, the data sent to interface 130 may be downscaled/compressed. However, compression can mean loss of image resolution, which may require a retiming of the frames before they are transmitted over interface 130. In one set of embodiments, a converter scaling unit may compress the image without loss of pixel resolution, thereby preventing the need to retime the frames before they are output over interface 130, as will be described next, with respect to FIG. 2.

FIG. 2 shows a partial block diagram of one embodiment of a computer system 200. Where applicable, components of system 200 have the same reference numerals as in FIG. 1. As shown, system 200 includes computing device 110, which is coupled to external display 160 via interface 130 and connection 150.

As described above with reference to FIG. 1, computing device 110 may be configured to operate in a mirror mode in which a single display generation unit provides output to displays 120 and 160. As used herein, and also in reference to the operation of display generation unit 210 as described above, the term “display generation unit” refers to any circuitry that may be used to generate graphics or pixel data for display, and may refer to pipelined circuitry that performs a series of graphical or pixel operations. FIG. 2 depicts a display generation unit 210 that provides output to internal display 120. While FIG. 2 shows the coupling between unit 210 and display 120 as a direct connection, in various embodiments, different circuitry or units (e.g., a PHY unit) may reside along this path. In general, a display controller may be included and operated in display generation unit 210, or may be coupled between display generation unit 210 and internal display 120 in order to properly display the graphics or pixel data on internal display 120. In one set of embodiments, the pixels provided by display generation unit 210 may be represented in the RGB color space.

FIG. 2 also depicts the output of display generation unit 210 being provided to external display 160 via a path that includes scaling unit 220, and interface 130. As with the connection between unit 210 and display 120, the connection between unit 210 and display 160 may have various units or circuitry in addition to those shown in FIG. 2. In one embodiment, display generation unit 210 includes separate pipelines for displays 120 and 160, with each of these pipelines divided into a front end and a back end. The front ends may deal with operations such as scaling, color space conversion, and blending, while the back ends may involve preparation of post-scaled and blended pixels for display on a panel (e.g., through a display controller). In one embodiment, the use of hardware mirror mode includes the back end of the display pipeline for the secondary display selecting as input the output of the front end of the display pipeline for the primary display. In other words, in one embodiment of display generation unit 210, the back end of the secondary display pipeline includes a multiplexer that, during operation in mirror mode, selects between the front-end outputs of the first and secondary display pipelines for further processing.

As described above, in some embodiments, the data width of interface 130 is less than that of an interface to primary display 120. In these situations, in order to effectuate display of images on secondary display 160 concurrently with display of images on primary display 120, interface 130 can be redesigned or the data passing through interface 130 may be compressed. Redesign of interface 130 may be problematic, particularly in situations in which the connector has been widely adopted over time.

In one embodiment, computing device 110 achieves concurrent display on external display 160 through bandwidth-limited interface 130 by scaling at least a portion of the data in between display generation unit 210 and interface 130. In the embodiment shown, a converter scaling unit 220 may perform color space compression, e.g. converting incoming pixel information represented in the RGB color space into pixel information represented in the YCbCr color space. The converter scaling unit 220 may subsequently downscale the chrominance information of the color converter pixels, thereby maintaining the geometric image resolution, while reducing the bandwidth of the data transmitted through interface 130. In other words, if the pixel information produced by display generation unit is not in a YCbCr color space format, (e.g. if it is in an RGB color space format), the pixel information may first be converted into the YCbCr color space format, and the chrominance information compressed as will be further described below. In embodiments where the pixel information is provided in the YCbCr color space format by display generation unit 210 to internal display 120, converter scaling unit 220 may operate on the received pixel information without requiring color space conversion. As one example, converter scaling unit 220 may receive 2048 pixels for a given line of a frame to be displayed on display 120, and there may be 1536 lines in a given frame. By compressing the chroma components of the pixel information and not the luma components, the same image resolution in terms of horizontal pixels by vertical pixels may be maintained for transmitting the pixel information through interface 130, thus not requiring a retiming of the frames to be transmitted over interface 130.

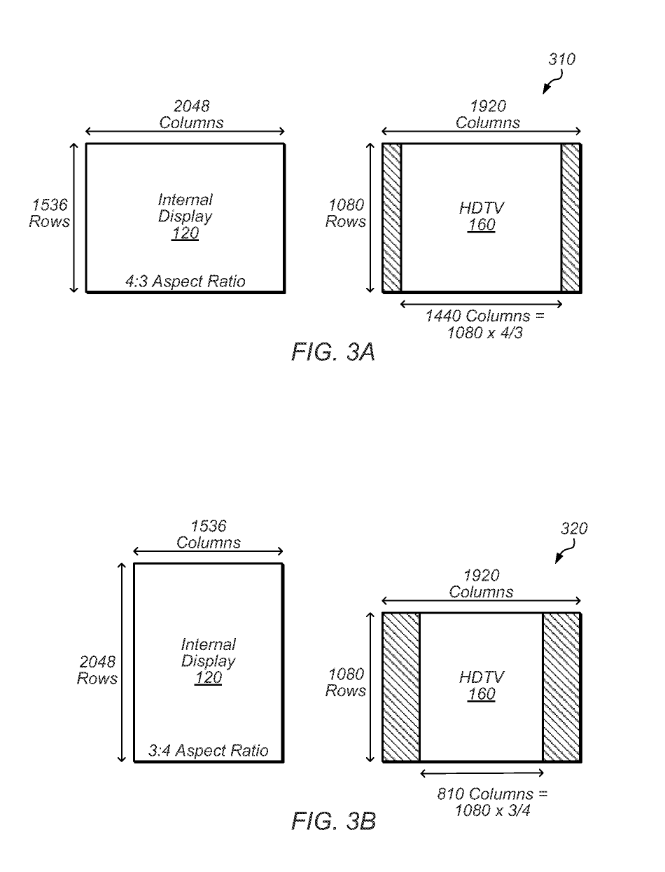

The implementation of FIG. 2 provides chroma scaled pixel data to interface 130. In one embodiment, converter scaling unit 220 applies a sufficient scale factor to the pixel data such that the data width of interface 130 can accommodate concurrent display of images on both displays. As will be described with reference to FIGS. 3A and 3B, by maintaining the original horizontal-pixel-per-vertical-pixel (HVP) image resolution—that is, the number of horizontal pixels per number of vertical pixels—unit 220 maintains the aspect ratio of the image on primary display 120 when displaying the image on secondary display 160. (Note, as used herein, the term “based on” is used to describe one or more factors that affect a determination. This term does not foreclose additional factors that may affect a determination. That is, a determination may be based solely on those factors or based at least in part on those factors. Consider the phrase “determine A based on B.” While B may be a factor that affects the determination of A, such a phrase does not foreclose the determination of A from also being based on C. In other instances, A may be determined based solely on B.)

Note that in some embodiments, for example when the screen resolution of external display 160 is less than the resolution of internal display 120, horizontal and vertical scaling between interface 130 and external display 160 may be required. The scaling factor in such cases may also need to account for additional factors, such as a current orientation of computing device 110 (i.e., whether device 110 is in a portrait or landscape mode). While it may be possible to perform such scaling within device 110, it would again require retiming of the frames as they are transmitted through interface 130, and the additional complexity that such scaling circuit would entail is not warranted when considering the typical frequency of the use of mirror mode as compared to the additional hardware resources that would need to be allocated to perform the HVP scaling within device 110. In the embodiment shown in FIG. 2, unit 220 performs chroma downscaling that is sufficient to meet the bandwidth limitations of interface 130. The configuration shown in FIG. 2 thus allows the mirror mode of device 110 to operate through a bandwidth-limited interface by performing scaling on the chroma component of the input pixel information, while leaving the luma component of the input pixel information intact, thereby retaining the HVP resolution of the image.

HVP scaling is thus performed outside of device 110. In the embodiment shown, scaling and rotating unit 230 is a hardware device located within connection 150. In one embodiment, unit 230 is a dongle that couples to interface 130 and provides a connection (either wired or wireless) to external display 160. Alternate embodiments are possible. For example, unit 230 could be situated at the other end of connection 150, or even within external display 160. The configuration shown in FIG. 2 thus allows the mirror mode of device 110 to operate through a bandwidth-limited interface by performing chroma scaling of input pixels and leaving HVP scaling (and rotating) to be handled off-device.

FIG. 3A shows example of scaling that may be performed by scaling and rotating unit 230. The dimensions (resolution) of internal display 120 are shown on the left (2048 columns by 1536 rows); the dimensions of external display 160 are shown on the right (1920 columns by 1080 rows). Note that primary display 120 has an aspect ratio (ratio of width to height) of 4:3; external display 160 has an aspect ratio of 16:9. Embodiments of the present disclosure may be applied to any suitable combination of primary and secondary display resolutions. In the example shown, display 120 may be the integrated display of a tablet computing device such as an iPad™ product, while external display 160 may be a HDTV display, such as those commonly used for presentations.

As discussed above, a problem may exist when a data width of interface 130 does not permit concurrent display of images on displays 120 and 160 (even leaving aside the differences in resolution). Chroma scaling unit 220 may operate to reduce the chroma channels by an amount sufficient to pass data through interface 130 at a rate that supports concurrent display of images (while leaving the luma channel uncompressed). In certain embodiments, unit 220 may thereby transmit an image having the same aspect ratio as that of the image displayed on display 120, which allows proportionately sized concurrent images to appear on displays 120 and 160 even when the resolution of display 160 differs from that of internal display 120.

In the example shown, an image displayed on display 120 at 2048×1536 pixels is ultimately downscaled to fit on a 1920×1080 display. In one embodiment, the scaling factor applied by unit 230 is based on whichever dimension (horizontal or vertical) needs the greatest amount of down-scaling. In FIG. 3A, more down-scaling is needed in the vertical direction (1536 rows to 1080 rows) than in the horizontal direction (2048 columns to 1920 columns). Accordingly, the number of output columns may be computed by multiplying the number of output rows by the aspect ratio of the original image (4:3). As shown in FIG. 3A, the number of output columns is 1080×(4/3)=1440. A sufficient horizontal scaling factor may therefore be applied by unit 230 to downscale 2048 columns to 1440 columns. Subsequently, a sufficient vertical scaling factor may be applied to downscale 1536 rows to 1080 rows. The resultant 1440×1080 image preserves the original aspect ratio of 4:3. As shown, certain columns on the left and the right of the display may be unused (e.g., blacked out) and only the middle 1440 columns used. The scaling factor applied in the horizontal dimension in this example is thus based on one of the resolutions of display 160 (in this case, the vertical dimension), as well as an aspect ratio of display 120.

For certain implementations of computing device 110, the aspect ratio of display 120 may change. In one embodiment, the aspect ratio of display 120 may change based on the orientation of device 110. For example, device 110 may be configured such that if it is oriented (e.g., by the user) in a “landscape” mode (as in FIG. 3A), the aspect ratio is 4:3, but if it is oriented in a “portrait” mode (as in FIG. 3B), the aspect ratio changes to 3:4. Accordingly, for identical hardware setups (e.g., the same combination of displays 120 and 160), the current horizontal scale factor may change based on a current orientation of device 110. FIG. 3B depicts example 320, in which display 120 is in a portrait orientation, such that the resolution is now 1536 rows by 2048 columns. Once again, the bigger down-scaling to display 160 is in the vertical dimension (2048 rows to 1080 rows); indeed, in this example, there are more columns on display 160 (1920) than on display 120 (1536). Accordingly, the number of output columns is 1080×(3/4)=810. As in example 310, display 160 may use only the middle 810 pixels of display 160 in one embodiment, blacking out an appropriate number of pixels on the left and right of the displayed image. In example 320, a horizontal scaling factor may be applied in unit 230 to downscale from 1536 columns to 810 columns. This scaling factor is based on one of the dimensions of display 160 (here, the vertical dimension), as well as the current orientation of display 120.

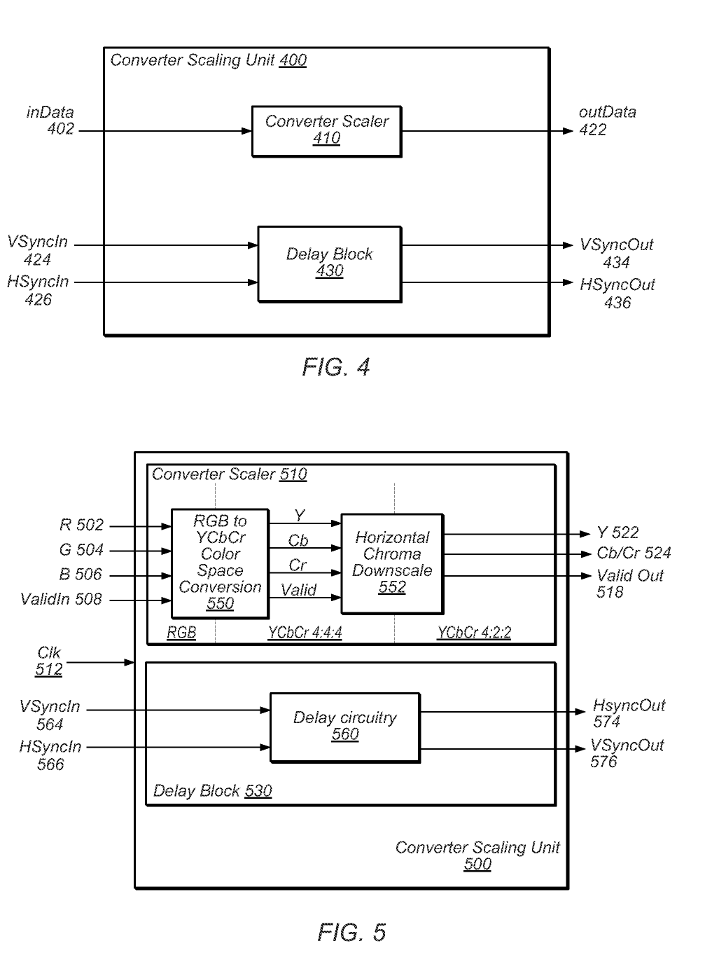

FIG. 4 shows a block diagram of one embodiment of a converter scaling unit 400. As has been described above, converter scaling unit 220 is configured to downscale the chroma values of YCbCr pixels produced by display generation unit 210, in order to reduce the amount of pixel data transmitted through interface 130, permitting concurrent display of images on displays 120 and 160. This process is represented in FIG. 4 by converter scaler unit 410, which receives input pixels (in Data 402) and downscales to produce output pixels (outData 406). To produce a synchronized image, however, timing issues need be considered. Since the HVP resolution of the image sent to internal display 120 and through interface 130 remains the same, the clock used by internal display 120 may also be used for external display 160, as there is a corresponding pixel sent to display 160 for each output clock pulse for which a pixel is sent to internal display 120.

The generation of vertical and horizontal control signals for display 160 (and also internal display 120) also need to be considered. Examples of such signals are shown with reference to FIGS. 8A (vertical control signals) and 8B (horizontal control signals). FIG. 8A also depicts the concept of a vertical blanking interval (VBI) (reference numeral 808), which is the period of time between the end of the last line of active pixel data of one frame and the beginning of the first line of pixel data of the subsequent frame. This blanking interval is composed of three periods: vertical sync 816, vertical back porch 818, and vertical front porch 814.

Vertical sync period 816 starts at the beginning of a frame. The vertical back porch period 818 starts at the end of vertical sync period 816 and lasts until the beginning of the first line of active pixel data (i.e., the beginning of vertical active period 812). The vertical front porch period 814 starts at the end of the last active line of pixel data and lasts until the beginning of the next frame (i.e. the beginning of the next vertical sync). Each of these periods may be defined as an integer multiple of the horizontal line time (reference numeral 854 in FIG. 8B).

Similarly, the horizontal blanking interval (HBI) 858 is the period between the last active pixel of one horizontal line and the first active pixel of the subsequent line, and is composed of a horizontal sync period 816, a horizontal back porch (HBP) period 868, and a horizontal front porch (HFP) period 864.

The horizontal sync period 816 starts at the beginning of a line. The horizontal back porch period 868 starts at the end of the horizontal sync period 816 and lasts until the first active pixel of the line (i.e., the beginning of horizontal active period 862—thus, for display 120, pixels are output on clock pulses occurring during horizontal active periods 862). The horizontal front porch period 864 starts after the last active pixel of the line, and lasts until the beginning of the next line (i.e. the beginning of the next horizontal sync). Each of these periods may be defined an integer multiple of the pixel time. Note that the HBI is typically observed for all line times, even those that occur during the VBI. One possible solution for generating the timing for display 160 is to use the clock (i.e., display 120's clock) as the clock during HBIs, which would also allow display 160 to use the input horizontal sync signal and the HBP and HFP periods associated with display 120. As seen in FIG. 4, a vertical synchronization signal VSyncIn 424 and a horizontal synchronization signal HSyncIn 426 may be generated and provided to converter scaling unit 400, where they may pass through a delay block 430, to produce output vertical and horizontal synchronization signals VSyncOut 434 and HSyncOut 436, respectively. Delay block 430 provides a delay commensurate with the delay between in Data 402 and outData 422, so that the relationship between the data and synchronization signals is maintained.

Turning now to FIG. 5, a block diagram of one embodiment of a converter scaling unit 500 is depicted. Unit 500 includes two primary blocks: converter scaler 510, and delay block 530. These blocks are responsible for the following tasks: converting (if necessary) incoming pixel data into the YCbCr color space, down-scaling the chroma components of the (converted) pixel data, and maintain timing between the pixel data and the corresponding synchronization signals. The interface of unit 500 may be designed to be fairly straightforward. In one embodiment, converter scaler 510 includes an interface that receives pixel data represented in the RGB color space. Thus, unit 510 receives an R 502 component input, a G 504 component input, and a B 506 component input, along with a ValidIn signal indicative of valid data. As indicated in FIG. 5, these signals are provided to an RGB to YCbCr color space conversion unit 550. The RGB data may be provided at the internal panel resolution (i.e. the resolution at which data is also provided to internal display 120, representing the same HVP resolution) to unit 550, which converts the incoming pixel data to the YCbCr 4:4:4 format (i.e., at this stage each of the three YCbCr components have the same sample rate).

The YCbCr 4:4:4 pixel data may then be passed to a horizontal chroma downscale unit 552, (e.g. a 2:1 downscaler) which may employ one of a number of possible methods (i.e. sample dropping, simple 2-sample averaging, multi-tap scaling, etc.) to halve the horizontal resolution of the Cr and Cb chroma components. The Y, Cb and Cr components are thus provided to unit 552, which samples the two chroma components at half the sample rate of the luma components, to halve the horizontal chroma resolution). This reduces the bandwidth of the uncompressed signal by one-third, with little to no visual difference perceptible to the human eye. The luma component Y is shown passing through unit 552 to ensure that it experiences the same latency as the chroma components, whatever that latency may be. Thus, unit 552 may produce a luma component output (Y, unchanged and full bandwidth) and a chroma component output (Cb/Cr 524, either Cr or Cb, at half bandwidth). In other words, unit 552 may output a luma value every clock cycle of Clk 512, while outputting either a Cb component or a Cr component during the same clock cycle, alternating between Cr component and Cb component from clock cycle to clock cycle. For example, during a first clock cycle, luma value 522 is output along with a Cr 524 value, during a second clock cycle, luma value 522 is output along with a Cb 524 value, during a third clock cycle, luma value 522 is output along with a Cr 524 value, etc. This is illustrated in FIG. 9, which shows a timing diagram 900 with the signals on the Y and Cr/Cb outputs of module 552, respectively. As seen in diagram 900, for each luma value output on the Y output, unit 552 alternately outputs a scaled Cr value and a scaled Cb value.

As seen in FIG. 5, unit 552 may also output a Valid Out signal 518 to indicate that valid Y 522 and Cb/Cr 524 signals are available. Delay block 530 may include delay circuitry 560, which may represent one or mode delay components and/or circuitry (e.g. logic circuitry), for adding latency to the synchronization signals VSyncIn 564 and HSyncIn 566, so that they remain aligned with the pixel data. In other words, the outputs ValidOut, VSyncOut, and HSyncOut may be thought of as delayed versions of the corresponding input signals ValidIn, VSyncIn, and HSyncIn, respectively. In the embodiment shown, the valid signal ValidIn 508 also passes through an identical latency path, but is used to control units 550 and 552. All operations may be performed according to clock signal Clk 512 provided to unit 500.

Overall, delay elements 560 are responsible for setting the phase offset between the input frame and the output frame. FIG. 7 demonstrates the operation of delay circuitry 560 by depicting the relative timing of a given input line 700 and corresponding output line 750. As shown, there is a DELAY period (set by block 560) at the beginning of output line 750. This time period allows output pixels to be generated by converter unit 550 and downscale unit 552. Note that input line 700 ends DELAY before the output line 750 just as input line 700 starts DELAY before output line 750. As shown, the line times of the input and output lines are equal. Accordingly, the frame times of the input and output frames can be kept equal and in sync, although pixels within individual lines in the output frame have a phase offset produced by delay circuitry 560 and are thus slightly out of phase with respect to corresponding input pixels. This may be referred to as an “isochronous” display of images. The phase offset is so slight in one embodiment that it is not visually perceptible by a user. As used herein, this display of slightly-out-of-phase frames at the same refresh rate is referred to as “concurrent,” “synchronized,” or “synchronous” display.

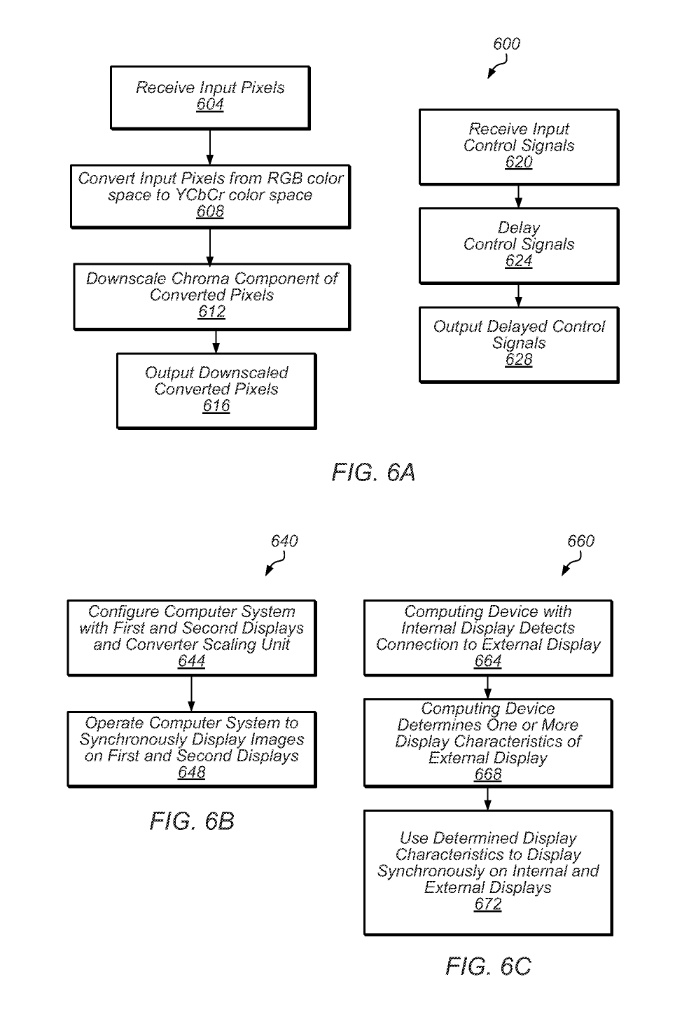

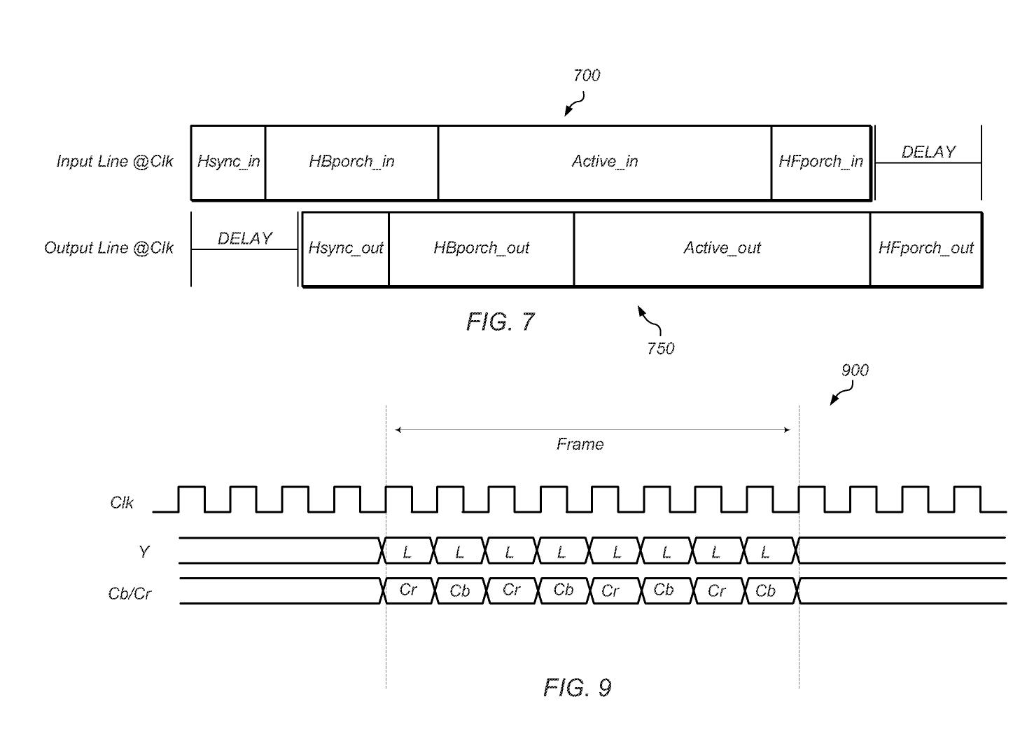

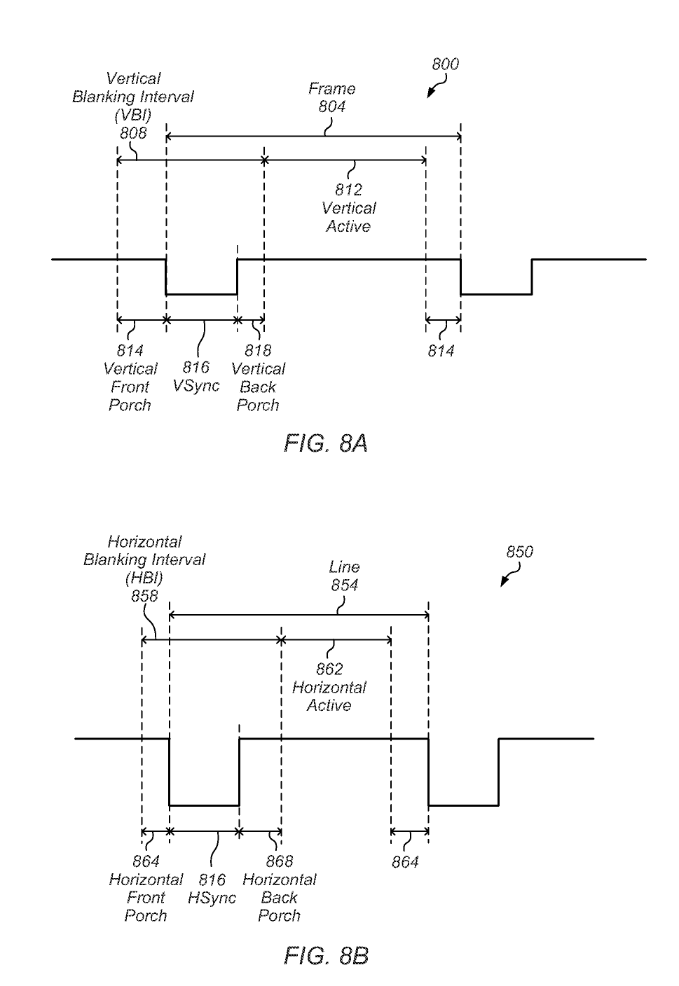

FIG. 6A shows a flow diagram of a method 600 depicting operation of one embodiment of a converter scaling unit. Method 600 includes two sets of operations, the first involving color space conversion and down-scaling the chroma component of the converted pixel information (steps 604, 608, 612, and 616), and the second involving the synchronization of control signals for the output frame (steps 620, 624, and 628). These two sets of operations may correspond to different data paths within an embodiment of a converter/scaling unit, and thus may be performed concurrently at least in part.

The pixel processing data path may begin in step 604, in which pixels from an input frame are received in display clock domain (e.g., by converter scaler unit 510). In step 608, if the pixels are received in an RGB color space format, they are converted from the RGB color space into the YCbCr color space. In step 612, the converted pixels are downscaled. More specifically, the chroma components of the YCbCr pixels are downscaled (e.g. halved), while the luma component is passed through unchanged. Then, in step 616, the downscaled converted pixels are output for display in the display clock domain. In one embodiment, a pixel is output when both the output horizontal and vertical active signals are asserted (e.g., during step 428).

The control signal data path begins in step 620, in which one or more control signals in the display clock domain are received. For example, in converter/scaling unit 510, a vertical sync input 564 and a horizontal sync input 566 are received to denote the start of an input frame. In step 624, the received sync signals are delayed, to match a delay resulting from the color space conversion and horizontal chroma downscaling performed by converter/scaling unit 510. The delayed sync signals are output in step 428. The delayed sync signals are output in sync with the downscaled converted pixels output in step 616.

FIG. 6B shows a flow diagram of a method 640, depicting operation of one embodiment of system 100. Method 640 is directed to making a presentation with device 110 in mirror mode using first and second displays and a converter scaling unit. In step 644, system 100 is set up (configured) such that computing device 110 having an internal (or primary) display and a converter scaling unit is connected to an external (or secondary) display. In step 648, system 100 is then operated to give the presentation (e.g., software running on device 110), displaying output images on display 120 and concurrently on display 160 using device 110's mirror mode. During operation, the orientation of device 110 may be changed, in which case an external scaler/rotator unit may perform the appropriate operation(s) on the output to produce images on display 160.

FIG. 6C shows a flow diagram of a method 660, depicting operation of one embodiment of computing device 110. In step 664, a computing device having an internal display detects a connection to an external display (e.g., via interface 130). In step 668, device 110 determines (e.g., through a handshaking protocol) one or more display characteristics of external display 160. For example, step 668 may determine a resolution of display 160 in one embodiment. In step 672, device 110 uses the determined characteristics to select one or more timing parameters (output clock frequency, output HBI, etc.), such as from a data store within device 110. The selected parameters are then used to operate a converter scaling unit such as unit 400 so that input and output resolutions remain the same, preventing the need to retime frames within system 100, thereby facilitating presentation of video/image information simultaneously on displays 120 and 160 in a mirror mode (as previously described).

Numerous variations and modifications will become apparent to those skilled in the art once the above disclosure is fully appreciated. It is intended that the following claims be interpreted to embrace all such variations and modifications.

We claim:

1. An apparatus comprising:
a display pipe unit configured to generate an image having a first resolution of horizontal pixels per vertical pixels (HVP) and configured to output the image as a data stream for display, wherein the data stream is represented in a first color space;
a color space converter configured to receive the data stream, and convert the data stream from the first color space to a second color space, to obtain a converted data stream;
a scaler configured to scale color information components of the converted data stream, to obtain a scaled converted data stream also having the first resolution of HVP; and
an interface configured to couple to an external display, and to receive the scaled converted data stream from the scaler, to display an output image represented by the scaled converted data stream on the external display.

2. The apparatus of claim 1;
wherein the first color space is a red-green-blue (RGB) color space;
wherein the second color space is a luminance-chrominance (YCbCr) color space, wherein the converted data stream comprises luma values and corresponding chroma values.

3. The apparatus of claim 2, wherein the scaler is configured to perform a horizontal chroma downscale during which a horizontal resolution of the chroma values is halved, while a resolution of the luma values remains the same.

4. The apparatus of claim 3, wherein the scaler is configured to:
output a respective luma value each clock cycle of a display controller clock; and
alternate outputting a respective chroma blue value and a respective chroma red value corresponding to the respective luma value each clock cycle.

5. The apparatus of claim 1, further comprising:
an internal display;
wherein the apparatus is configured to implement a mirror mode in which the apparatus is configured to synchronously display the output image on the internal display and the external display.

6. A method, comprising:
receiving a pixel stream representative of image/video frames having a specified horizontal-pixels-per-vertical-pixels (HVP) resolution and intended for display on an internal display monitor, wherein the pixel stream is in a first color space;
converting the received pixels stream from the first color space to a second color space, to obtain a respective luma value and respective corresponding chroma values for each pixel in the converted pixel stream;
scaling the respective corresponding chroma values for each pixel, to reduce a bandwidth required to output the converted pixel stream, wherein output frames represented by the scaled converted pixel stream retain the specified HVP resolution; and
outputting the scaled converted pixel stream for displaying the output frames on an external display monitor.

7. The method of claim 6, wherein scaling the respective chroma values comprises halving a horizontal resolution of the respective chroma values.

8. The method of claim 6, further comprising synchronously displaying the output frames on the internal display monitor and the external display monitor in a mirror mode.

9. The method of claim 6, further comprising:
receiving a set of control signals corresponding to the received pixel stream; and
delaying the set of control signals by a time period commensurate with a time period elapsed during the converting and the scaling.

10. The method of claim 9, further comprising outputting the delayed set of corresponding control signals in sync with the scaled converted pixel stream.

11. A method, comprising:
receiving red-green-blue (RGB) pixel data generated at a specified horizontal-pixels-per-vertical-pixels (HVP) resolution corresponding to an internal display panel;
receiving control signals associated with the RGB pixel data;
converting the received RGB pixel data to YCbCr pixel data;
downscaling a horizontal resolution of chroma components of the YCbCr pixel data while maintaining the specified HVP resolution; and
outputting a luma component and the downscaled chroma components of the YCbCr pixel data in sync with the received control signals, for display on an external display.

12. The method of claim 11, further comprising delaying the received control signals by a time period commensurate with a time period elapsed during the converting and the downscaling;
wherein outputting the luma component and the downscaled chroma components of the YCbCr pixel data in sync with the received control signals comprises simultaneously outputting the delayed control signals and the luma component and the downscaled chroma components.

13. The method of claim 11, wherein the control signals comprise one or more of:
a vertical synchronization signal;
a horizontal synchronization signal; or
a data valid signal.

14. The method of claim 11, wherein outputting the downscaled chroma components comprises alternately outputting a downscaled chroma red component and a downscaled chroma blue component.

15. The method of claim 11, further comprising displaying the YCbCr pixel data on the external display.

16. An apparatus, comprising:
a converter scaler unit configured to:
receive images having a specified horizontal/vertical resolution corresponding to a primary display, the images represented as RGB pixel data;
convert the RGB pixel data into YCbCr 4:4:4 pixel data;
downscale chroma components of the YCbCr 4:4:4 pixel data to obtain YCbCr 4:2:2 pixel data;
receive a horizontal sync signal and vertical sync signal corresponding to the RGB pixel data, and generate a corresponding horizontal sync signal output and a corresponding vertical sync signal output; and
output the YCbCr 4:2:2 pixel data in sync with the horizontal sync signal output and the vertical sync signal output.

17. The apparatus of claim 16, further comprising:
a primary display; and
an interface configured to couple to a secondary display;
wherein the apparatus is configured to synchronously display the RGB pixel data on the primary display and the YCbCr 4:2:2 pixel data on the secondary display.

18. The apparatus of claim 16, wherein the converter scaler unit comprises a delay unit configured to receive the horizontal sync signal and vertical sync signal, and generate the horizontal sync signal output and the vertical sync signal output by delaying the horizontal sync signal and the vertical sync signal to match a delay experienced while the converter scaler unit converts the RGB pixel data and downscales the chroma components of the YCbCr 4:4:4 pixel data.

19. The apparatus of claim 16, wherein the converter scaler unit is further configured to:
receive a data valid signal corresponding to the RGB pixel data and indicative of valid pixels;
generate an data valid signal output; and
output the data valid signal output in sync with the YCbCr 4:2:2 pixel data to indicate that the YCbCr 4:2:2 pixel data is valid.

20. The apparatus of claim 16, wherein in downscaling the chroma components of the YCbCr 4:4:4 pixel data, the converter scaler unit is configured to downscale a horizontal resolution of the chroma components by performing one of:
sample dropping;
simple two-sample averaging; and
multi-tap scaling.

21. An apparatus, comprising:
a display pipe unit configured to generate an image represented in red-blue-green (RGB) color space and having a specified horizontal-vertical resolution, and configured to output the image as a data stream for display;
a converter scaler coupled to receive the data stream and configured to:
convert the data stream from the RGB color space to YCbCr color space during transmission of the data stream; and
downscale chroma components of the converted data stream to reduce a bandwidth of the converted data stream during transmission of the converted data stream; and
an interface to an external display coupled to receive the downscaled converted data stream from the converter scaler, wherein the interface comprises a two-wire display port interface configured to provide the downscaled converted data stream to the external display;
wherein a luma component of the downscaled converted data stream remains uncompressed to maintain the specified horizontal-vertical resolution.

22. The apparatus of claim 21, further comprising:
an internal display configured to receive the data stream for display, wherein the apparatus is configured to display the data stream on the internal display and the downscaled converted data stream on the external display synchronously in a mirror mode.

23. The apparatus of claim 21, wherein the converter scaler is configured to alternately output a downscaled chroma red component and a downscaled chroma blue component to the interface each cycle of a display port clock, while simultaneously outputting a corresponding luma component.

24. The apparatus of claim 23, wherein the converter scaler unit is configured to receive input horizontal sync, vertical sync, and data valid signals, and generate output horizontal sync, vertical sync, and data valid signals aligned with the downscaled converted data stream, and output the output horizontal sync, vertical sync, and data valid signals along with the downscaled converted data stream.
